(19) United States
(12) Patent Application Publication
(10) Pub. No.: US 2006/0072317 A1
(43) Pub. Date: Apr. 6, 2006

(54) Automatic illuminating device

(76) Inventor: Benjamin P. Noordhoek, Kentwood, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/243,788

(22) Filed: Oct. 5, 2005

Related U.S. Application Data
(60) Provisional application No. 60/616,066, filed on Oct. 5, 2004.

(51) Int. Cl. F21V 9/00

(52) U.S. Cl. 362/231

(57) ABSTRACT

An illuminating device includes a control device with manual or programmable color schemes providing selected color combinations of lights. A timing device or the like may be utilized to activate the selected color combination or combinations at selected dates and times. The illuminating device may include incandescent or LED light sources of various colors, or colored lenses or the like. The illuminating device may include a programmable processor and a communication device capable of transmitting and receiving a wired or wireless signal.

### CROSS-REFERENCE TO RELATED APPLICATION

This application claims the benefit of U.S. Provisional Application No. 60/616,066, filed on Oct. 5, 2004, the entire contents of which are incorporated by reference.

### BACKGROUND OF THE INVENTION

The present invention relates to an automatic illuminating device and, in particular, to a device which may be incorporated into existing illuminating devices.

Consumers often purchase incandescent lights or the like for different seasons of the calendar year. These lights may have various color schemes utilized for various holidays and/or events. Once installed, conventional illuminating display devices may illuminate a specific colored bulb or LED and may display a specific image and/or a blinking or scrolling light pattern. Once the aforementioned season and/or event that the consumer is recognizing has passed, consumers must then remove, take down or change the respective season's or event's colors, image or blinking and/or scrolling light arrangements or patterns. Alternatively consumers often forget to replace the conventional season's or event's colors, images, or blinking or scrolling light arrangements or patterns with the desired arrangement, which may include, among others, either a conventional white light arrangement the next season and/or events' colors or images, or blinking or scrolling light arrangements scrolling patterns. This replacement and maintenance of conventional lighting devices increases the time consumers must spend arranging their conventional lighting for various holidays and/or events. This required replacement and maintenance means that the consumer must physically replace the bulbs or color schemes of conventional lighting devices.

Therefore, there is a need for convenient, user-friendly automatic illuminating device that may receive a communication signal and/or is easily programmable by a consumer.

### SUMMARY OF THE INVENTION

One aspect of the present invention is an automatic illuminating device including a manual control device having user input features for selecting at least one preprogrammed color setting defining at least one color combination and associated time. The device further includes a multi-colored light arrangement generating light of at least first and second colors corresponding to the color combination. The first color is visibly distinct from the second color. A controller is operably coupled to the manual control device and to the multi-colored light arrangement. The processor activates the multi-colored light arrangement and generates the at least first and second colors at the associated time.

Another aspect of the present invention is an illumination device including a plurality of discreet light sources. At least a first one of the discreet light sources produces light of a first color, and at least a second one of the discreet light sources produces light of a second color that is visibly different than the first color. At least a third one of the discreet light sources produces light of a third color that is visibly different from the first and second colors. The illumination device further includes a controller having a plurality of color settings stored therein. A first one of the color settings includes at least two of the first, second and third colors to define a first pair. A second color setting includes at least two of the first, second and third colors to define a second pair, wherein the second pair includes different ones of the first, second and third colors than the first pair. An input device has a plurality of input features enabling a user to select one of the color settings stored in the controller for activation. The controller is coupled to the plurality of discreet light sources and turns on selected ones of the discreet light sources according to the color setting selected by a user.

Yet another aspect of the present invention is a multi-colored lighting device including a plurality of discreet light sources. At least a first one of the discreet light sources produces light of a first color, and at least a second one of the discreet light sources produces light of a second color that is visibly different than the first color. The lighting device includes a switching system configured to supply electrical power to selected ones of the discreet light sources to thereby turn on either the first one of the discreet light sources, the second one of the discreet light sources, or simultaneously turn on both the first and second ones of the discreet light sources. A receiver is coupled to the switching system and controls the switching system based at least in part on a signal received by the receiver.

These and other features, advantages, and objects of the present invention will be further understood and appreciated by those skilled in the art by reference to the following specification, claims, and appended drawings.

### BRIEF DESCRIPTION OF THE DRAWINGS

The invention will now be described further by way of example only and with reference to the accompanying drawings in which:

FIG. 1 is a partially schematic view of light arrangements according to several aspects of the present invention;

FIG. 2 is an LED light arrangement for use in a conventional bulb socket to provide an illuminating device according to one aspect of the present invention;

FIG. 3 is a base for holding a plurality of incandescent lights/light bulbs in a conventional bulb socket to provide an illuminating device according to another aspect of the present invention;

FIG. 4 is a schematic view of an illuminating arrangement according to one aspect of the present invention; and

FIG. 5 is a wall mountable insert to either be in hard-wired communication or remote-control communication with a multi-color illuminating device according to one aspect of the present invention.

### DETAILED DESCRIPTION OF PREFERRED EMBODIMENT

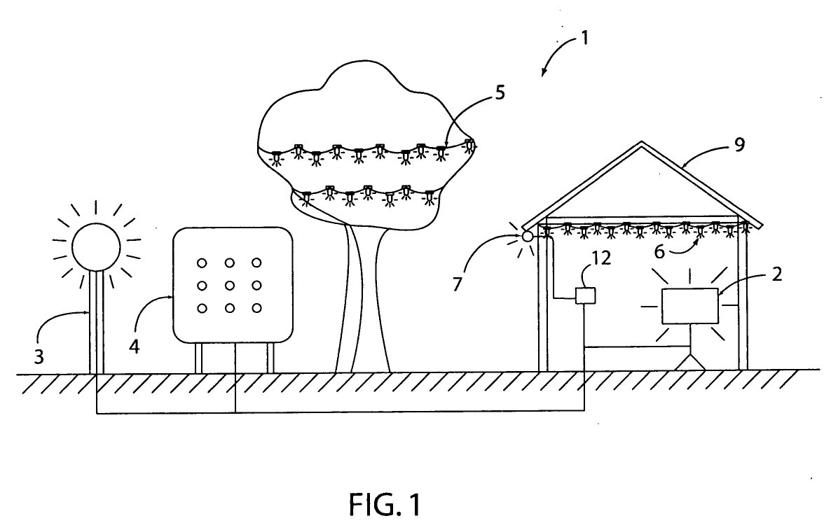

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The multi-color illuminating display device 1 of the present invention may receive/transmit a communication signal and/or is easily programmable by a consumer.

The automatic illuminating device 1 may be utilized in either an indoor light fixture 2 or outdoor light fixtures such as lamp 3, panel 4, light strings 5 and 6, or repositionable fixture 7. These lighting arrangements may automatically change colors to acknowledge various events, including, but not limited to, national and religious holidays, birthdays, anniversaries, various organizational events, including, but not limited to, sporting events, community programs/events, historical dates/events, political events/opinions, etc. The illuminating device 1 may be pre-programmed by, for example, a consumer, or it may be pre-programmed to provide a specific combination of colors. The illuminating device 1 may also include a receiver and/or transmitter to receive/transmit a communication signal. When illuminating device 1 is configured in this way, a consumer could, for example, subscribe to a service such that information may be communicated via the automatic illuminating display device.

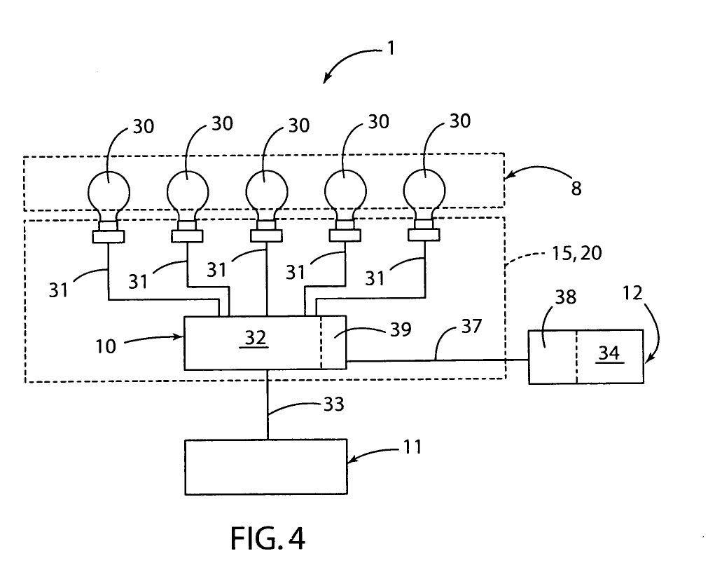

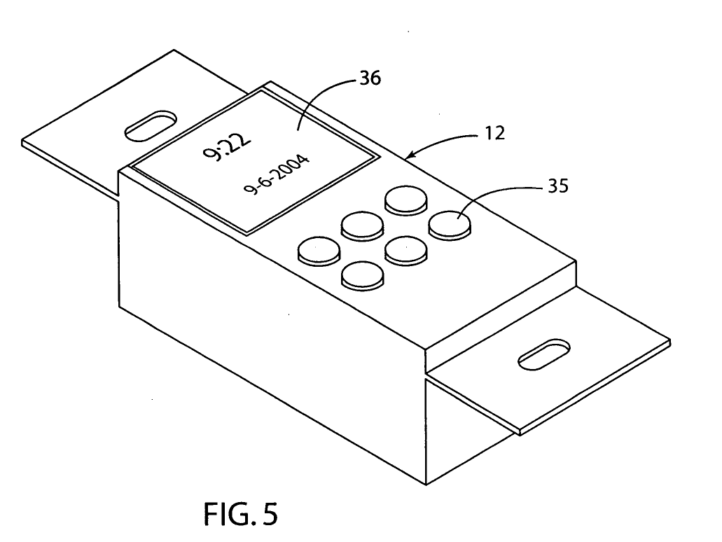

An automatic illuminating display device 1 of the present invention may include an illuminating portion 8 (FIG. 4), a color changing device 10, a clock or other controlled time device, a light socket, and a power source 11. A clock may optionally be used in any embodiment of the present invention. In use, a user may utilize a control input device 12 (see also FIG. 5) to program certain dates and/or times into the device 1. When the clock indicates that a pre-determined date has arrived, the automatic display device 1 displays a pre-programmed color or color arrangement having a specific color or combination of colors. Alternatively, device 1 may utilize, either in conjunction with the clock as described above, or absent the clock as described above, a manual control device 12. The manual control device 12 allows the user to select the color or combination of colors to be displayed at a preselected date/time. The manual control device 12 may include one or more pre-programmed settings which allow a user to set the automatic illuminating device 1 to a pre-programmed color scheme having a specific color or combination of colors at a point in time selected by the user. For example, the manual control device 12 may include color settings such as red, blue, green, orange, etc. The manual control device 12 may also include one or more programmable settings that are stored in a memory device in manual control device 12 or a controller or the like elsewhere that is operably coupled to the system. A user may pre-program one of the programmable settings to illuminate for example, the colors of his/her favorite sports team, college, or university at a particular time, such as the day of a sporting event or the like.

The manual control device 12 may either be wirelessly connected to the illuminating display device or connected via a wired arrangement. Also, known differences will occur in the arrangement between an LED (Light Emitting Diode) automatic illuminating device and an incandescent automatic illuminating device. For example, it will be understood that an LED light arrangement would include an appropriate circuit to drive the LEDs.

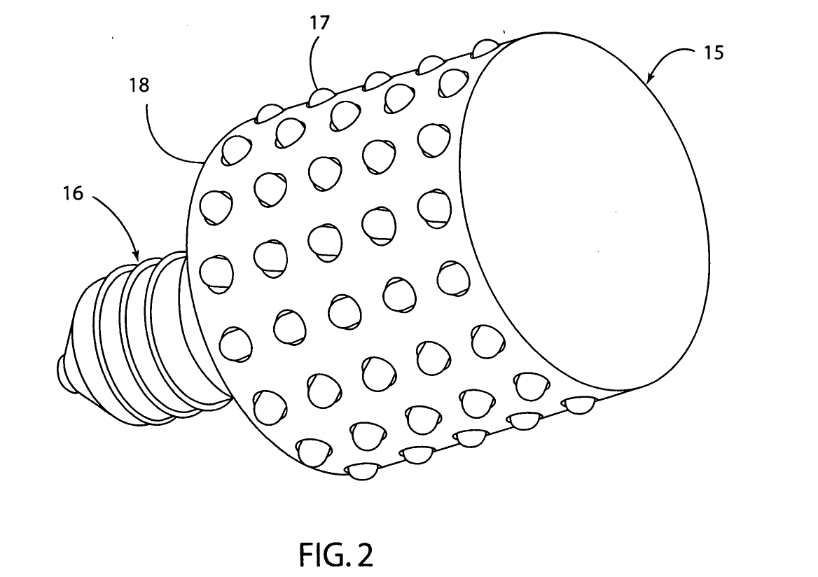

With reference to FIG. 2, an example of an LED light fixture arrangement 15 according to one aspect of the present invention includes a threaded electrical connector 16 that can be received in a conventional incandescent light socket. A plurality of LED light sources 17 are mounted to a cylindrical body portion 18 and project light outwardly from the LED light arrangement 15. In general, LEDs 17 generate light of at least two different colors, and preferably three or more colors. As discussed in more detail below in connection with FIG. 4, LED light arrangement 15 may include a receiver that receives a control signal from a color changing device 10 having a remote transmitter and a controller. LED fixture 15 may include a switching circuit or the like that controls which of the individual LEDs 17 of specific colors are activated. It will be understood that the selected combination of colors may be turned on at a preselected time or manually turned on by a user. Such a device may be programmed and/or utilized in connection with some other type of communication or controlled time device. The device typically includes a color changing LED arrangement in connection with the color changing device 10. The display device 1 with LED light fixture 15 may include a battery backup (not shown) to hold memory in event of a power outage.

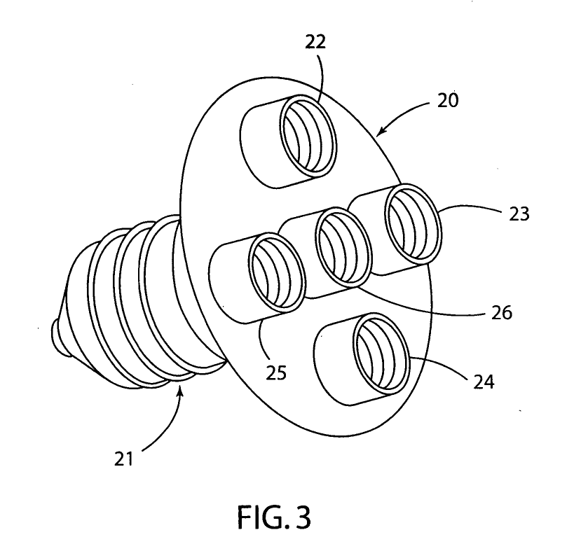

With further reference to FIG. 3, an incandescent light arrangement 20 may be used in the display device 1. Such an arrangement generally includes multiple colored light bulbs or colored lenses. Incandescent light arrangement 20 includes a threaded connector portion 21 that is received in a conventional light bulb socket. A plurality of threaded sockets 22-26 are operably coupled to the connector 21. Sockets 22-26 receive incandescent bulbs (not shown) of two or more different colors to provide light of a selected color or combination of colors. As discussed in more detail below in connection with FIG. 4, light arrangement 20 may include a receiver that receives a control signal from a remote transmitter/controller, and a switching circuit or the like to control which socket(s) 22-26 receive power to thereby light the incandescent bulb or bulbs to provide a specific color or combination of colors.

A controller and/or multiple relays for controlling which of the bulbs are lit may be in wired communication with the light sockets 22-26. The controller and/or relays may be in direct or wired communication with a clock or some other communication or controlled time device. The processor generally interprets the signal from the communication or controlled time device. The processor processes this signal(s) and then controls the communication output to the multiple relays. Such a device may also have a capacitor or battery backup to retain information stored in memory in event there is a power outage.

It will be understood that light arrangements 15 and 20 may include a switching circuit to turn on and off one or more selected bulbs or LEDs without use of remote transmitter/controller. Alternately, a controller and use input interface may be built into light arrangements 15 and 20 to provide user control and/or programming without use of a receiver and transmitter. Also, device 1 may include a sensor that only turns on the lights of the selected color combination if it becomes dark outside during the date/time interval selected for the particular color combination.

Each of these devices may be controlled with a wired or wireless remote control. In the wireless remote control arrangement, a known remote signal creator, coding switch and processor are typically utilized in the automatic illuminating device of the present invention.

With further reference to FIG. 4, illuminating device 1 may include an illuminating portion 8, a color changing device 10, and a control input device 12. Illuminating portion 8 includes a plurality of light sources 30 that may be either LED lights 17, or incandescent bulbs. Each light source 30 generates a specific color light due to a specific LED or incandescent light configuration, or via colored lenses or coatings or the like. The individual light sources 30 produce light of at least two distinct colors, and preferably a large number of colors corresponding to at least each of the colors of the visible spectrum. In the illustrated example, each of the light sources 30 is operably connected to the color changing device by a power line 31. The color changing device 10 includes a first component 32 that includes a switching circuit, controller, or the like to selectively supply power to the individual power lines 31 to thereby selectively light selected ones of the light sources 30. It will be understood that the controller may be located in the control input device 12, or in the light fixture arrangement 15 or 20, or elsewhere. A source of electric power 11 is coupled to the color changing device 10 by a line 33 or the like. Control input device 12 includes a first portion 34 that may include a plurality of input controls such as buttons 35 (also see FIG. 5), and a display screen 36 that notifies the user of the programmed arrangements and/or prompts user inputs to program the controller and/or select a preprogrammed light color and time scheme. Input control device 12 may be operably coupled to the color changing device 10 by a conductive line 37 or the like. Alternately, control input device 12 may include transmitter 38 that sends a wireless signal to a receiver 39 that is coupled to first component 32.

With reference back to FIG. 1, it will be appreciated that the illuminating device 1 of the present invention may be utilized in a wide range of configurations, both exterior of a building 9, or inside the building 9. The controller may be programmed to illuminate lights of a specific color at a specific date and time to celebrate a particular holiday or other event. The controller may be programmed to include a large number of such programs, such that a given light arrangement 2-7 may be utilized to provide color combinations for a range of events or the like. For example, the controller may be programmed to light the exterior lights in Christmas colors such as red, green, and/or white starting at a particular date (e.g., the day after Thanksgiving) and ending at a certain date (e.g., shortly after Christmas Day). The same controller may also be programmed to provide lights in colors corresponding to an individual's favorite sports team on game days. A light sensor may also be utilized to turn the selected color combination on only at night during the selected date/time interval. It will be readily understood that the individual LED and/or incandescent lights in the illuminating device may include a very wide range of colors to provide for a very wide range of potential color combinations. Also, it will be understood that the lighting arrangements 2-7 illustrated in FIG. 1 are typically utilized as alternate versions or aspects of illuminating device 1. However, numerous light arrangements 2-7 having different configurations may be utilized at the same time if so desired.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An automatic illuminating device, comprising:
a manual control device including user input features for selecting at least one pre-programmed color setting defining at least one color combination and associated time;
a multi-colored light arrangement generating light of at least first and second colors corresponding to the color combination, wherein the first color is visibly distinct from the second color;
a controller operably coupled to the manual control device and to the multi-colored light arrangement, wherein the processor activates the multi-colored light arrangement and generates the at least first and second colors at the associated time.

2. The automatic illuminating device of claim 1, wherein:
the multi-colored light arrangement comprises a threaded male light socket configured to be received in a female light socket, and a plurality of light sources operably coupled to the male light socket.

3. The automatic illuminating device of claim 2, including:
a plurality of relay switches interconnecting the male light socket and the light sources to turn on selected ones of the plurality of light sources, wherein the plurality of relay switches are controlled by the controller.

4. The automatic illuminating device of claim 3, wherein:
the plurality of light sources comprise LEDs.

5. The automatic illuminating device of claim 3, wherein:
the multi-colored light arrangement further comprises a plurality of threaded female light sockets; and
the plurality of light sources comprises a plurality of incandescent bulbs received in the female light sockets.

6. The automatic illuminating device of claim 1, including:
a transmitter coupled to the manual control device and generating a signal;
a receiver coupled to the controller to provide control of the controller when the controller is remote from the manual control device.

7. The automatic illuminating device of claim 1, wherein:
the manual control device comprises a housing, and the controller is mounted in the housing.

8. The automatic illuminating device of claim 1, wherein:
the multi-colored light arrangement comprises a string of spaced-apart discreet light sources.

9. The automatic illuminating device of claim 1, wherein:
the multi-colored light arrangement comprises a panel having an array of spaced-apart discreet light sources.

10. The automatic illuminating device of claim 1, wherein:
the multi-colored light arrangement comprises an elongated vertically extending support member.

11. The automatic illuminating device of claim 1, including:
a receiver coupled to the controller, wherein the receiver is configured to receive a radio signal from a remote source.

12. An illumination device, comprising:
a plurality of discreet light sources, at least a first one of the discreet light sources producing light of a first color, and at least a second one of the discreet light sources producing light of a second color that is visibly different than the first color, at least a third one of the discreet light sources producing light of a third color that is visibly different from the first and second colors;
a controller having a plurality of color settings stored therein, a first one of the color settings including at least two of the first, second, and third colors to define a first pair, a second color setting including at least two of the first, second, and third colors to define a second pair, and wherein the second pair includes different ones of the first, second and third colors than the first pair;
an input device having a plurality of input features enabling a user to select one of the color settings stored in the controller for activation, and wherein:
the controller is coupled to the plurality of discreet light sources and turns on selected ones of the discreet light sources according to the color setting selected by a user.

13. The illumination device of claim 12, including:
a timing device; and wherein:
at least one of the color settings includes time information, the controller turning on the selected ones of the discreet light sources based, at least in part, on the time information.

14. The illumination device of claim 13, wherein:
the time information includes the date of a sporting event of a sports team.

15. The illumination device of claim 13, wherein:
the time information includes a date corresponding to a holiday.

16. The illumination device of claim 12, including:
a transmitter coupled to the input device; and
a receiver coupled to the controller for receiving a signal from the transmitter.

17. A multi-colored lighting device, comprising:
a plurality of discreet light sources, at least a first one of the discreet light sources producing light of a first color and at least a second one of the discreet light sources producing light of a second color that is visibly different than the first color;
a switching system configured to supply electrical power to selected ones of the discreet light sources to thereby turn on either the first one of the discreet light sources, the second one of the discreet light sources, or simultaneously turn on both the first and second ones of the discreet light sources; and
a receiver coupled to the switching system and controlling the switching system based at least in part on a signal received by the receiver.

18. The multi-colored lighting device of claim 17, including:
an input device having user input features and a display screen, the input device including a transmitter generating a signal to the receiver.

19. The multi-colored lighting device of claim 18, including:
a controller having a plurality of color settings stored there, each color setting corresponding to a different combination of light colors produced by the discreet light sources.

20. The multi-colored lighting device of claim 19, wherein:
each color setting includes a time at which the controller activates a selected one of the color settings.
